(19) United States
(12) Patent Application Publication
(10) Pub. No.: US 2011/0271330 A1
(43) Pub. Date: Nov. 3, 2011

(54) SOLUTIONS FOR IDENTIFYING LEGAL USER EQUIPMENTS IN A COMMUNICATION NETWORK

(75) Inventor: Dajiang Zhang, Beijing (CN)

(73) Assignee: NOKIA (CHINA) INVESTMENT CO. LTD., BEIJING (CN)

(21) Appl. No.: 13/143,084

(22) PCT Filed: Dec. 31, 2008
(86) PCT No.: PCT/CN08/73890

§ 371 Date: Jun. 30, 2011

(51) Int. Cl. H04L 9/32

(52) U.S. Cl. 726/5

(57) ABSTRACT

A method for identifying legal user equipments in a communication network is provided. The method comprises: sending to a user equipment a request for an identity of the user equipment; receiving from the user equipment a response to the request, the response comprising the identity of the user equipment and an associated credential; and determining whether the user equipment is a legal one, according to a result of authentication based at least in part on the received identity and the credential.

### FIELD OF THE INVENTION

The present invention generally relates to communication networks. More specifically, the invention relates to solutions for identifying legal User Equipments (UEs) in a communication network.

### BACKGROUND OF THE INVENTION

The International Mobile station Equipment Identity (IMEI) is a unique identity (ID) of a User Equipment (UE). The International Mobile station Equipment Identity and Software Version number (IMEISV), as defined in TS23.003, is a 16-digit decimal number composed of three distinct elements, i.e. Type Allocation Code (TAC), Serial Number (SNR), and Software Version Number (SVN), as shown in Table I.

TABLE I
Composition of the IMEISV

| TAC | SNR | SVN |
|---|---|---|
| 8 digits | 6 digits | 2 digits |

### SUMMARY OF THE INVENTION

According to a first aspect of the present invention, there is provided a method for identifying legal user equipments in a communication network, comprising: sending to a user equipment a request for an identity of the user equipment; receiving from the user equipment a response to the request, the response comprising the identity of the user equipment and an associated credential; and determining whether the user equipment is a legal one, according to a result of authentication based at least in part on the received identity and the credential.

According to a second aspect of the present invention, there is provided a network device comprising: sending means for sending to a user equipment a request for an identity of the user equipment; receiving means for receiving from the user equipment a response to the request, the response comprising the identity of the user equipment and an associated credential; and determining means for determining whether the user equipment is a legal one, according to a result of authentication based at least in part on the received identity and the credential.

According to a third aspect of the present invention, there is provided a method for identifying legal user equipments in a communication network, comprising: receiving a request for an identity of a user equipment; generating a credential associated with the identity of the user equipment; and sending a response comprising the identity and the credential to a network device.

According to a fourth aspect of the present invention, there is provided a user equipment comprising: receiving means for receiving a request for an identity of the user equipment; generating means for generating a credential associated with the identity of the user equipment; and sending means for sending a response comprising the identity and the credential to a network device.

According to a fifth aspect of the present invention, there is provided a computer program comprising computer program code to, when loaded into a computer system and executed thereon, cause said computer system to: send to a user equipment a request for an identity of the user equipment; receive from the user equipment a response to the request, the response comprising the identity of the user equipment and an associated credential; and determine whether the user equipment is a legal one, according to a result of authentication based at least in part on the received identity and the credential.

According to a sixth aspect of the present invention, there is provided a computer program comprising computer program code to, when loaded into a computer system and executed thereon, cause said computer system to: receive a request for an identity of a user equipment; generate a credential associated with the identity of the user equipment; and send a response comprising the identity and the credential to a network device.

In embodiments of the present invention, the provided solutions can identify legal UEs in a communication network, and prevent illegal UEs from accessing the communication network without affecting those legal UEs.

### BRIEF DESCRIPTION OF THE DRAWINGS

The invention itself, the preferable mode of use and further objectives are best understood by reference to the following detailed description of the embodiments when read in conjunction with the accompanying drawings, in which:

FIG. 1 is a flowchart illustrating a method for identifying a legal UE in a communication network, which can be implemented at a network device in accordance with embodiments of the present invention;

FIG. 2 is a flowchart illustrating a method for identifying a legal UE in a communication network, which can be implemented at a UE in accordance with embodiments of the present invention;

FIG. 3 shows schematically a message flow diagram of a solution based at least in part on a certificate in accordance with an embodiment of the present invention;

FIG. 4 shows schematically a message flow diagram of a solution based at least in part on a one-time password in accordance with another embodiment of the present invention;

FIG. 5 is a block diagram of a network device in accordance with embodiments of the present invention; and

FIG. 6 is a block diagram of a UE in accordance with embodiments of the present invention.

### DETAILED DESCRIPTION OF THE INVENTION

UE manufacturers apply IMEIs from Global System for Mobile Communications Association (GSMA) or Telecommunication Terminal Testing & Approval Forum (TAF). However, some UE manufacturers may produce UE illegally. For example, some UE manufactures may have no license issued by regulators, or the UE manufactures may not apply IMEIs from GSMA or TAF, but copy or clone IMEIs of legal UEs. The UE manufactured illegally is the illegal UE. Network operators may block the illegal UE to access a mobile communication network through adding the IMEI of the illegal UE into a list. The list contains IMEIs of illegal UEs. For example, a network operator may detect whether there are more than one UE with the same IMEI appearing in the network. If founded, the network operator may block all the UEs with that IMEI. But with this solution, the legal one is also blocked as it is difficult to distinguish the legal UE from illegal UEs solely based on IMEI. There is a need to design a solution for identifying legal UEs in a communication network, so as to detect and prevent illegal UEs from accessing the communication network.

The embodiments of the present invention are described in detail with reference to the accompanying drawings. Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

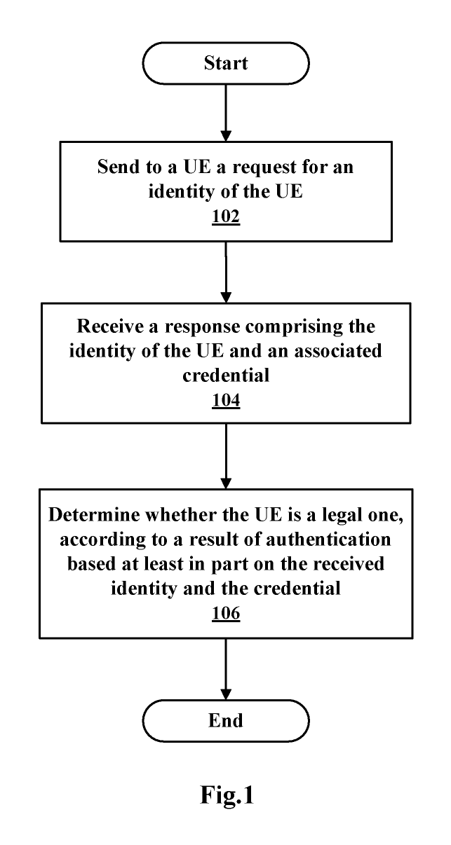

FIG. 1 is a flowchart illustrating a method for identifying a legal UE in a communication network, which can be implemented at a network device in accordance with embodiments of the present invention. The network device, for example, may be a MSC (Mobile services Switching Centre), a SGSN (Serving General Packet Radio Service (GPRS) Support Node), a MME (Mobility Management Entity) or any other network elements (for example, an AAA (Authentication, Authorization and Accounting) server) with similar functionalities of being capable of performing or assisting in authentication of a UE. The UE herein may refer to a mobile phone, a wireless device, a Personal Digital Assistant (PDA), a portable computer, a client terminal, or the like. When a network operator wants to identify legal UEs or to detect illegal UEs in the network, according to FIG. 1, a request for an identity of a UE will be sent from the network device to the UE, as shown in step 102. It will be appreciated that the identity of the UE may be an IMEI or any other identifier which can identify the UE uniquely.

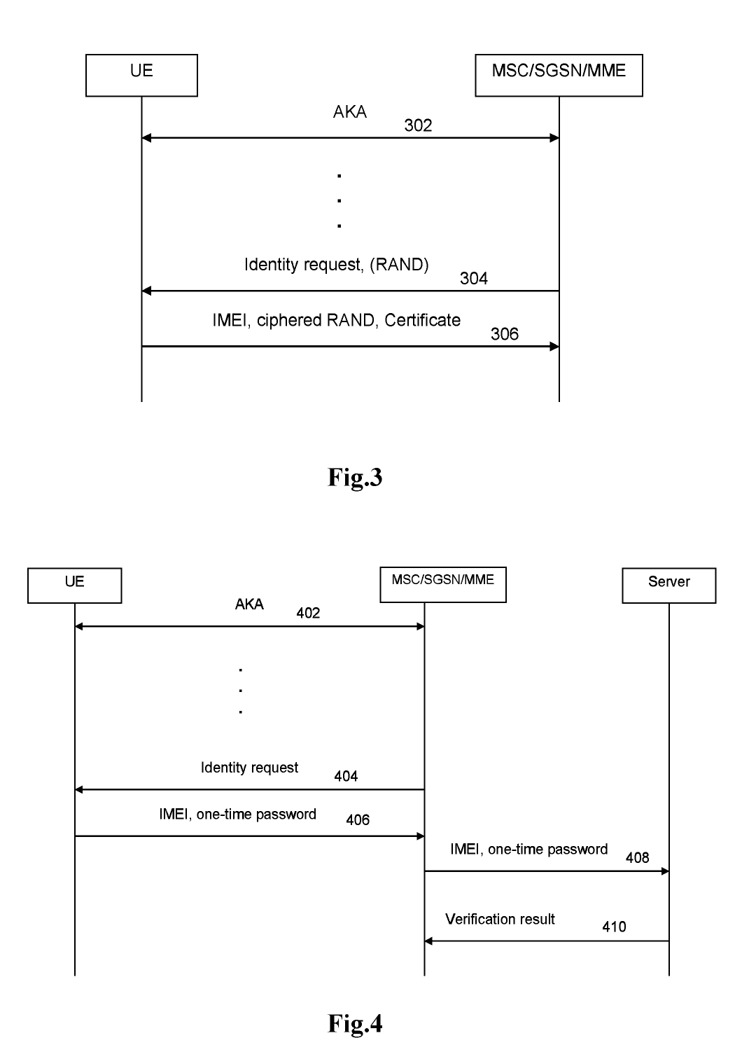

Upon receipt of a response to the request from the UE in step 104, the network device can determine whether the UE is a legal one, according to a result of authentication based at least in part on the identity and an associated credential comprised in the response, as shown in step 106. According to different authentication mechanisms, the associated credential may be a cipher along with a certificate, a one-time password, or the like. Solution I (i.e., a solution based at least in part on a certificate as detailed in FIG. 3), Solution II (i.e., a solution based at least in part on a one-time password as detailed in FIG. 4), or a suitable combination of these two solutions can be adopted in an authentication procedure. Depending on a result of the determination in step 106, a network operator can take appropriate actions, for example, block a UE when the UE is verified as an illegal UE (for example an illegal UE). With the method 100, the network operator can identify legal UEs in the network, and prevent illegal UEs from accessing the network without affecting those legal UEs.

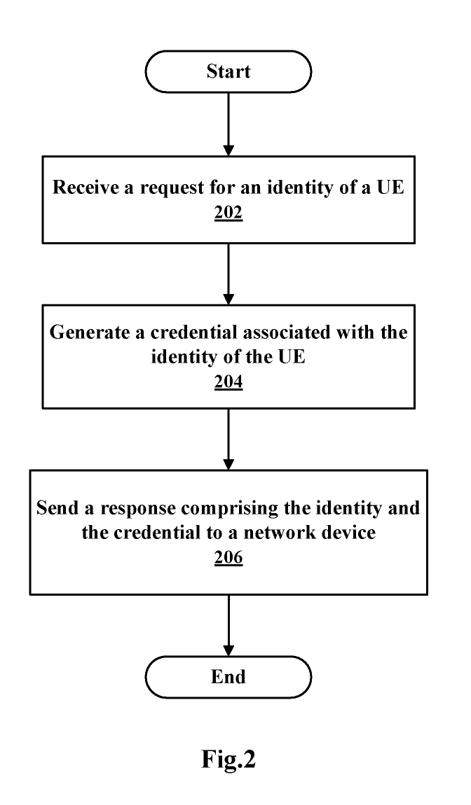

FIG. 2 is a flowchart illustrating a method for identifying a legal UE in a communication network, which can be implemented at a UE such as a mobile device, a portable computer, a wireless communication terminal, and etc., in accordance with embodiments of the present invention. When receiving a request for an identity of a UE from a network device (for example, MSC/SGSN/MME) at step 202, the UE generates a credential associated with its identity (for example, IMEI), as shown in step 204. As described above, this credential may be a cipher along with a certificate, a one-time password, or the like. Therefore, the UE can generate applicable credentials based on various algorithms, depending on different authentication policies between the network device and the UE. For example, the UE can encrypt a content (for example, a random number) provided by the network device based at least in part on a private key pairing with a public key in a pre-assigned identity certificate, as detailed in FIG. 3, or derive a one-time password based at least in part on a seed stored in the UE and current time of the UE, as detailed in FIG. 4.

Upon generation of the credential, the UE will comprise its unique identity and the associated credential in a response to the request for the identity, and send this response to the network device for authentication of the UE, as shown in step 206. Depending on a result of the authentication, the UE may receive a “success” message or a “failure” message from the network device (not shown), whereby the owner of the UE may learn whether his/her UE is a legal one in the communication network being attempted to access.

The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

FIG. 3 shows schematically a message flow diagram of a solution based at least in part on a certificate (hereinafter also referred as Solution I) in accordance with an embodiment of the present invention. In Solution I, an identity certificate is pre-assigned to a UE. For example, a UE manufacturer or GSMA can issue a certificate to each IMEI. At the UE side, an IMEI certificate is installed during manufacture. This certificate can be signed by a manufacturer, a standardization body like GSMA or a trusted third party (for example, certificate authority) as a certificate which is accepted by operator. In addition, the private key pairing with the public key in the IMEI certificate is also stored in a secure memory of the UE and can not be read by a user. The private key may be used to encrypt a content (for example, a random number) received from a network device, for example, MSC/SGSN/MME. The encrypted content is sent as a credential to the MSC/SGSN/MME together with the IMEI of the UE and its pre-assigned certificate. At a network side, the network device, for example MSC/SGSN/MME, can verify the IMEI certificate, decrypt the ciphered content received from the UE, and compare it with the content which is stored at the network side and previously sent to the UE.

In order not to obscure the present invention, some initial communication interactions between a UE (for example, the UE in FIG. 3 and FIG. 4) and a network device (for example, the MSC/SGSN/MME in FIG. 3 and FIG. 4) are omitted. Thus, before performing Solution I to identify legal UEs in a network, a connection between the UE and the MSC/SGSN/MME may, but not necessarily, have been established, for example, by an AKA (Authentication and Key Agreement) procedure 302 or other appropriate communication procedures. As shown in FIG. 3, the network device (for example, MSC/SGSN/MME) sends 304 to the UE a request message for the UE's identity (for example, IMEI). A random number (RAND) is also sent to the UE in the request message, as indicated in FIG. 3. Alternatively, a random number which is transmitted to the UE in previous messaging (e.g. in the AKA procedure 302) might be reused.

The UE encrypts the received random number based at least in part on a private key pairing with a public key in its IMEI certificate, and sends this ciphered random number back to the network together with the UE's IMEI and certificate 306. Some well-known unsynchronized cryptograph algorithms, for example RSA (Rivest Shamir Adlemen) can be used here for encrypting the received random number. When receiving a response message from the UE, the SGSN/MSC/MME verifies the IMEI certificate therein (not shown in FIG. 3). If the certificate is valid, the SGSN/MSC/MME can decrypt the ciphered random number based at least in part on the public key in the verified IMEI certificate (with an algorithm corresponding to that used at the UE), and compare the decrypted random number with its stored random number. If these two random numbers are matched, then the UE is determined as a legal one. In this way, a network operator can authenticate the UE. As mentioned above, the random number used in AKA (which is performed when the UE is accessing the network) can be reused here.

FIG. 4 shows schematically a message flow diagram of a solution based at least in part on a one-time password (hereinafter also referred as Solution II) in accordance with an embodiment of the present invention. In Solution II, a one-time password is used as a credential together with an identity such as IMEI of a UE. At a UE side, for example, a seed for deriving the one-time password can be stored in a tamper-resistant chip. The one-time password is created and sent to a MSC/SGSN/MME together with the UE's IMEI, as a response message to an IMEI request from a network. At the network side, a server stores a pair of seed and IMEI for this UE. The server may be provided by the UE manufacturer or a third party allowed by both the manufacturers and network operators. The MSC/SGSN/MME can generate a new one-time password based at least in part on a seed corresponding to the IMEI in the response message. This seed can be retrieved from the server through an interface between the server and the MSC/SGSN/MME. Thus the MSC/SGSN/MME verifies the UE by comparing the new one-time password with the received one-time password in the response message. Alternatively, such verification also can be done in the server, and a result of the verification will be transmitted to the MSC/SGSN/MME.

With reference to FIG. 4, when a UE is attempting to access a network, for example, an AKA procedure 402 or other communication procedures may be set up between the UE and a network device such as MSC/SGSN/MME. In case of Solution II, upon receipt of an identity request sent 404 from the MSC/SGSN/MME, the UE derives a one-time password based at least in part on a seed stored in a tamper-resistant chip and current time of an embedded timer in the UE. Some known algorithms, for example HASH algorithm SHA-256 (Secure Hash Algorithm-256), SHA-1 and MD5 (Message-Digest Algorithm 5), can be used to derive this one-time password. Then the UE sends 406 its IMEI together with the derived one-time password in a response message to the MSC/SGSN/MME. At the network side, each UE manufacturer or a trusted third party provides a server storing pairs of IMEIs and seeds. With the received identity of the UE, the network can find the seed for authentication of this UE, for example, by checking the TAC of the IMEI to find out the manufacturer of the UE. Then the IMEI and the associated one-time password are sent 408 to the corresponding server. The server retrieves the stored seed for the received IMEI, generate a new one-time password based at least in part on its current time and the retrieved seed by using an algorithm corresponding to that used at the UE. Then the generated one-time password and the one-time password received from UE are compared. If these two one-time passwords are matched, then the UE is determined as a legal one. The verification result is returned 410 to the MSC/SGSN/MME from the server. In this way, a network operator can authenticate the UE. It should be noted that the MSC/SGSN/MME also may perform the authentication by itself (not shown in FIG. 4), and may retrieve from the server the seed pairing with the received IMEI to generate a new one-time password for authentication of the UE.

In Solution II, in order to maintain those pairs of seeds and identities of UEs, a server may be provided. An interface between the server and a network device such as MSC/SGSN/MME needs to be introduced. The interface may be based on legacy protocols, for example Lightweight Directory Access Protocol (LDAP). Moreover, the synchronization of the time of the Chip between the UE and the server (or between the UE and the MSC/SGSN/MME if authentication is performed in the MSC/SGSN/MME) needs to be carefully designed. Considering the delay caused by network, the used timer preferably falls into a time slot rather than an exact point.

In an embodiment, for both solutions, a new SVN of the IMEI may be defined to indicate that a specific solution or policy is used to identify legal UEs, so that a MSC/SGSN/MME may continue to proceed with the data following the IMEI, for example, an IMEI certificate and a ciphered random number, or a one-time password.

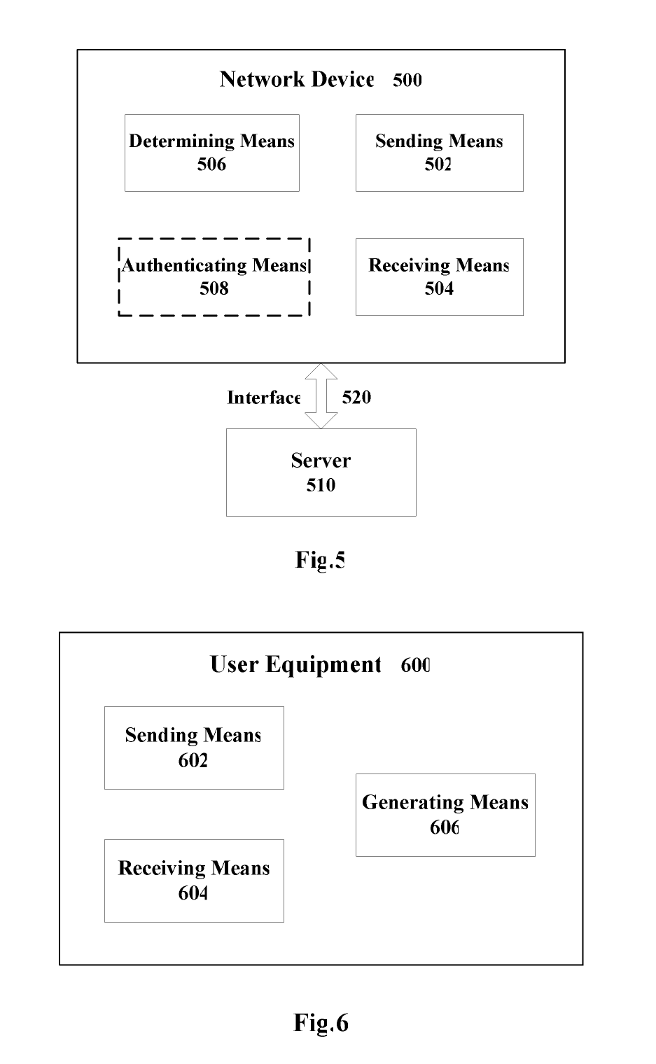

FIG. 5 is a block diagram of a network device 500 in accordance with embodiments of the present invention. As shown in FIG. 5, the network device 500, such as the MSC/SGSN/MME in FIG. 3 and FIG. 4, comprises sending means 502, receiving means 504, and determining means 506. Alternatively, the network device 500 may further comprise authenticating means 508 (as indicated by dash line in FIG. 5) for authenticating a UE. The sending means 502, the receiving means 504, the determining means 506 and the authenticating means 508 may be coupled to each other by a variety of communication links and/or interfaces. Furthermore, the network device 500 may be connected to a server 510 (such as the server shown in FIG. 4) via an interface 520, as illustrated in FIG. 5. In this case, the server 510 may provide the network device 500 with information such as a seed pairing with an identity of the UE to be authenticated, and such information can be pre-installed in the server 510 by manufacturers or other third parties. In an embodiment of the present invention, in order to reduce the burden of the network device 500, the authenticating means 508 may be located in the server 510, instead of in the network device 500, such that the authentication of the UE can be done in the server 510. Thus, the network device 500 can only retrieve information from a database (not shown) within the server 510, as required by the authenticating means 508 in the network device 500, or can obtain a result of authentication from the server 510 directly if the authenticating means 508 is located in the server 510.

When a communication network operator needs to identify legal UEs or detect illegal UEs in the communication network, the network device 500 can be utilized to perform this. The sending means 502 may send a request to a UE (such as a UE 600 shown in FIG. 6) in the communication network for a respective identity, such as IMEI. In an exemplary embodiment, if Solution I is adopted during an authentication procedure, the sending means 502 may further send to the UE a content (for example a parameter of RAND) in the request for the identity, or in previous communication procedures such as AKA. When receiving from the UE, by the receiving means 504, a response to the request, the identity of the UE and an associated credential comprised in this response are forwarded to the authenticating means 508.

If the adopted authentication mechanism is based on Solution I, as illustrated in FIG. 3, the received response may further comprise an identity certificate pre-assigned to the UE, in addition to the identity of the UE and the associated credential. In this scenario, the authentication means 508 in the network device 500 verifies the certificate and extracts a public key in the verified certificate. The received credential, which is a ciphered content (for example, a ciphered random number) generated by the UE in this case, can be decrypted based at least in part on the extracted public key. Then the authentication means 508 compares the decrypted content with its stored content in a memory of the network device 500 (not shown in FIG. 5).

In the case of Solution II as illustrated in FIG. 4, the received credential is a one-time password derived by the UE. In this circumstance, the authentication means 508 retrieves, from the database in the server 510, a seed pairing with the received identity of the UE, in despite of whether the authentication means 508 is located in the network device 500 or the server 510. Based at least in part on the retrieved seed and current time of the authentication means 508, a new one-time password can be generated. The current time of the authentication means 508 may be obtained, for example, from a timer (not shown) in the authentication means 508. Then the authentication means 508 will compare the new generated one-time password with the received one-time password.

According to a result of authentication provided by the authentication means 508, the determining means 506 can determine whether the UE is a legal one. Thus the operator can identify legal UEs in the communication network and block illegal UEs.

FIG. 6 is a block diagram of a UE 600 in accordance with embodiments of the present invention. As shown in FIG. 6, the UE 600, such as the UE in FIG. 3 and FIG. 4, comprises sending means 602, receiving means 604 and generating means 606. For example, with a connection between the sending means 502 and the receiving means 604, and a connection between the receiving means 504 and the sending means 602, the UE 600 can communicate with the network device 500.

When the receiving means 604 receives a request for an identity of the UE from a network device such as the network device 500 in FIG. 5, the generating means 606 generates a respective credential associated with the identity of the UE 600, depending on the adopted authentication solutions between the network device and the UE. Upon generation of the credential, the sending means 602 sends a response comprising the identity and the associated credential to the network device for authenticating the UE 600.

In case of Solution I, the generating means 606 encrypts a content (for example, a random number) provided by the network device based at least in part on a private key. The private key pairs with a public key in an identity certificate which is pre-assigned to the UE 600 by its manufacturer or a specific standardization body like GSMA or a trusted third party (for example, a certificate authority). Accordingly, the identity certificate is also sent by the sending means 602 to the network device in the response, so that the network device can decrypt the ciphered content (i.e. the credential associated with the identity of the UE 600). In case of Solution II, the generating means 606 derives a one-time password based at least in part on its current time and a seed pairing with the identity of the UE 600.

It should be noted that FIG. 5 and FIG. 6 only show some important components of a UE and a network device. Those skilled in the art will realize that the network device 500 and the UE 600 may comprise other functional means and/or modules not shown. For example, the UE 600 may comprise a tamper-resistant chip to store a private key pairing with a public key in a certificate signed for the UE 600.

The present invention can be realized in hardware, software, firmware or the combination thereof. The present invention also can be embodied in a computer program product, which comprises all the features enabling the implementation of the methods and apparatuses or devices described herein, and when being loaded into the computer system, is able to carry out these methods or constitute the functional means/modules in the apparatuses or devices according to embodiments of the present invention.

Although specific embodiments of the invention have been disclosed, those having ordinary skill in the art will understand that changes can be made to the specific embodiments without departing from the spirit and scope of the invention. The scope of the invention is not to be restricted therefore to the specific embodiments, and it is intended that the appended claims cover any and all such applications, modifications, and embodiments within the scope of the present invention.

1.-29. (canceled)

30. A method for identifying legal user equipments in a communication network, comprising:
sending to a user equipment a request for an identity of the user equipment;
receiving from the user equipment a response to the request, the response comprising the identity of the user equipment and an associated credential; and
determining whether the user equipment is a legal one, according to a result of authentication based at least in part on the received identity and the credential.

31. The method according to claim 30, wherein the credential is a first one-time password derived based at least in part on a seed stored in the user equipment and current time of the user equipment.

32. The method according to claim 31, wherein said authentication comprises:
retrieving, from a database, a seed corresponding to the received identity of the user equipment;
generating a second one-time password based at least in part on the retrieved seed and current time of the authentication;
comparing the second one-time password with the first one-time password, wherein if the second one-time password matches to the first one-time password, the user equipment is determined as a legal one.

33. The method according to claim 30, wherein the response further comprises an identity certificate pre-assigned to the user equipment, and the received credential is a ciphered content generated by encrypting a first content based at least in part on a private key stored at the user equipment, the private key pairing with a public key in the pre-assigned identity certificate; and wherein the first content is provided to the user equipment in the request for the identity or in previous messaging.

34. The method according to claim 33, wherein said authentication comprises:
verifying the identity certificate;
decrypting the received credential based at least in part on a public key in the verified identity certificate to get a second content;
comparing the second content with the first content, wherein if the second content matches to the first content, the user equipment is determined as a legal one.

35. The method according to claim 30, wherein the identity of the user equipment comprises an International Mobile station Equipment Identity and a Software Version Number of the International Mobile station Equipment Identity is defined to indicate that a specific policy is used to identify a legal user equipment.

36. A network device, configured to:
send to a user equipment a request for an identity of the user equipment;
receive from the user equipment a response to the request, the response comprising the identity of the user equipment and an associated credential; and
determine whether the user equipment is a legal one, according to a result of authentication based at least in part on the received identity and the credential.

37. The network device according to claim 36, wherein the credential is a first one-time password derived based at least in part on a seed stored in the user equipment and current time of the user equipment.

38. The network device according to claim 37, wherein the result of the authentication is provided by the following:
retrieve, from a database, a seed corresponding to the received identity of the user equipment;
generate a second one-time password based at least in part on the retrieved seed and current time of the authentication; and
compare the second one-time password with the first one-time password; wherein when the second one-time password matches to the first one-time password, the user equipment is determined as a legal one.

39. The network device according to claim 36, wherein the response further comprises an identity certificate pre-assigned to the user equipment, and the received credential is a ciphered content generated by encrypting a first content based at least in part on a private key stored at the user equipment, the private key pairing with a public key in the pre-assigned identity certificate; and wherein the first content is provided by the network device to the user equipment in the request for the identity or in previous messaging.

40. The network device according to claim 39, wherein the result of the authentication is provided by the following:
verify the identity certificate;
decrypt the received credential based at least in part on a public key in the verified identity certificate to get a second content; and
compare the second content with the first content, wherein when the second content matches to the first content, the user equipment is determined as a legal one.

41. The network device according to claim 36, wherein the identity of the user equipment comprises an International Mobile station Equipment Identity and a Software Version Number of the International Mobile station Equipment Identity is defined to indicate that a specific policy is used to identify a legal user equipment.

42. The network device according to claim 36, wherein the network device comprises one of a Mobile services Switching Centre, a Serving General Packet Radio Service Support Node, a Mobility Management Entity, and an Authentication Authorization and Accounting server.

43. A user equipment, configured to:
receive a request for an identity of the user equipment;
generate a credential associated with the identity of the user equipment; and
send a response comprising the identity and the credential to a network device.

44. The user equipment according to claim 43, wherein the credential is a one-time password, wherein
the one-time password is derived based at least in part on a seed stored in the user equipment and current time of the user equipment.

45. The user equipment according to claim 44, wherein the credential is a ciphered content, and the response further comprises an identity certificate pre-assigned to the user equipment, wherein
the ciphered content is the encryption of a content provided by the network device in the request for the identity or in previous messaging based at least in part on a private key stored at the user equipment, the private key pairing with a public key in the pre-assigned identity certificate and.

46. The user equipment according to claim 44, wherein the identity of the user equipment comprises an International Mobile station Equipment Identity; and a Software Version Number of the International Mobile station Equipment Identity is defined to indicate that a specific policy is used to identify a legal user equipment.

47. The user equipment according to claim 44, wherein the network device comprises one of a Mobile services Switching Centre, a Serving General Packet Radio Service Support Node, a Mobility Management Entity, and an Authentication Authorization and Accounting server.
